(19) United States
(12) Patent Application Publication
(10) Pub. No.: US 2025/0054647 A1
(43) Pub. Date: Feb. 13, 2025

(54) Electron Suppressor Electrode for Improved Efficiency and In-Situ Electron Monitoring

(71) Applicant: Alpha Ring International, Ltd., Grand Cayman (KY)

(72) Inventor: Allan Xi CHEN, Cypress, CA (US)

(21) Appl. No.: 18/448,061

(22) Filed: Aug. 10, 2023

(51) Int. Cl. G21B 3/00

(52) U.S. Cl. CPC G21B 3/006

(57) ABSTRACT

Back-streaming of electrons toward an ion beam source is prevented by disposing an electron suppressor electrode asymmetrically with respect to the ion beam and biasing a voltage of the electron suppressor electrode relative to a voltage of a target to prevent back-streaming of electrons to the ion beam source. The electron suppressor electrode can be either positively or negatively biased with respect to the target.

### FIELD OF THE DISCLOSURE

This disclosure relates generally to beam-target fusion resulting from ion beam bombardment of a target, and more particularly, to an electron suppressor electrode that increases fusion efficiency and facilitates in-situ electron monitoring.

### BACKGROUND

Beam-target fusion experiments are used in a wide variety of fields, including in scientific experiments to study fusion science, and in commercial applications such as neutron generators and isotope production.

Beam-target fusion techniques are used to conduct scientific research on fusion reactions, and to produce byproducts of commercial value (such as Helium-3, tritium, and neutron production).

Beam-target fusion apparatuses operate by bombarding a target with energetic ions. Referring to FIG. 1, a typical beam-target fusion apparatus 100 generally includes three parts: an ion source 120, an extraction electrode 115, and a target 110. Ions may be extracted from a plasma created by the ion source 120 and accelerated in a beam 130 towards the target 110 using the extraction electrode 115. Once the ions traverse past the aperture of the extraction electrode 115, they enter a drift region which contains many of the ion beam diagnostics and instrumentation (e.g. optical viewport, pressure gauge, RGA, pumps, etc.)

Some of the ions in the beam 130 will collide with atoms or ions present in the target 110 (either because they are pre-loaded or because the ion beam itself loads the target) and a fusion reaction may result. One common reaction used in such an apparatus is deuterium-deuterium (so-called “D-D”) fusion, which produces various byproducts, including Helium-3 isotopes, tritium isotopes, protons, and neutrons as mentioned above.

Due to the finite travel distance in the drift region, some of the ions will also collide with the neutral background gas to generate so-called back-streaming electrons. These back-streaming electrons travel in the opposite direction to the ion beam and will be naturally attracted to the ion source, which is biased to a high positive potential. This, in turn, necessitates a much higher current and power draw from the biasing high voltage (HV) supply for the ion source than would be needed in the absence of the back-streaming electrons.

Ion sources can be configured to produce both positive ions (i.e., those with a lesser number of electrons than protons) and negative ions (i.e., those with a greater number of electrons than protons). In either case, the management of undesirable back-streaming electrons is important.

In the case of a negative ion source, the extraction electrode and target are biased with a positive voltage relative to the ion source (with the target typically being slightly more positively biased than the extraction electrode). One of the main challenges with negative ion source design is how to deal with so-called “co-extracted electrons.” Extracting unwanted electrons along with the negative ions from the ion source is unavoidable because both have the same charge. These undesirable co-extracted electrons will collide with the target and be scattered back towards the ion source, producing an adverse effect on the output flow of negative ions which, in turn, lowers the efficiency of the entire system.

In the case of a positive ion source, the extraction electrode and target are biased with a negative voltage relative to the ion source. In this case, the problem is not co-extracted electrons from the ion source, but rather electrons that are emitted from the target surface when it is bombarded by the energetic beam of positive ions. These backscattered electrons will be attracted towards the positively charged ion source and create a current adverse to the flow of positive ions. As in the negative ion source case, the unwanted electrons lower the efficiency of the entire system.

One method of dealing with unwanted electrons is to introduce a so-called suppressor electrode into the apparatus design. Conventionally, suppressor electrodes in a beam-target apparatus are typically disc-shaped and negatively biased relative to the target. Alternatively, suppressor electrodes have been configured as either a pair of electrodes (forming a dipole configuration) disposed symmetrically around the route of the ion beam, or as a ring electrode through which the energetic beam passes. FIG. 2 illustrates an example of a beam-target fusion apparatus 200 that includes an ion source 120, an extraction electrode 115, and a target 110 with a suppressor electrode 212 disposed between the target 110 and the extraction electrode 115.

Improved configurations of suppressor electrodes that exhibit increased fusion efficiency and facilitate in-situ electron monitoring are desirable.

### SUMMARY

Described herein is a sub-assembly consisting of a rod-shaped suppressor electrode and a diagnostic circuit that is part of a larger assembly that includes a target and ion source and is designed to facilitate “beam-target” fusion reactions. The present inventor has appreciated that a suppressor electrode may advantageously be configured in a rod-like shape that can be positioned flexibly within the beam-target fusion apparatus and not necessarily disposed symmetrically with respect to the ion beam.

According to an embodiment, a system comprises a target; an ion beam source configured to create a plasma from which an ion beam is emitted along an axis toward the target; and an electron suppressor electrode disposed asymmetrically with respect to the ion beam, and configured to suppress back-streaming of electrons toward the ion beam source.

According an embodiment, a method is provided for suppressing back-streaming of electrons toward an ion beam source configured to create a plasma from which an ion beam is emitted along an axis toward a target. The method comprises disposing an electron suppressor electrode asymmetrically with respect to the ion beam and biasing a voltage of the electron suppressor electrode relative to a voltage of the target to prevent back-streaming of electrons to the ion source.

### BRIEF DESCRIPTION OF THE DRAWINGS

Exemplary embodiments herein will be more particularly understood from the following detailed description in conjunction with the accompanying drawings, in which:

FIG. 1 is a diagram of a conventional beam-target fusion apparatus;

FIG. 2 is a diagram of a conventional beam-target fusion apparatus with a conventional electron suppressor electrode; and

FIG. 3 is a diagram of a beam-target fusion apparatus having an electron suppressor, according to embodiments described hereinbelow.

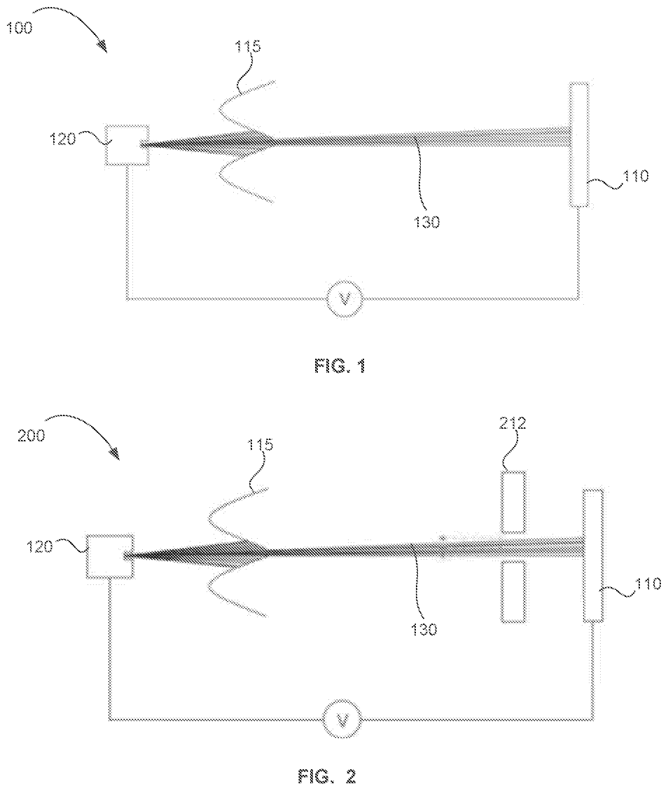

### DETAILED DESCRIPTION

Exemplary embodiments will now be described with reference to the accompanying drawings. The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated. Thus, aspects of the embodiments should not be construed as being limited to description herein. Rather, these embodiments serve to enable a person skilled in the pertinent art to make and use these embodiments and others that will be apparent to those skilled in the art.

It will be understood that when a feature is referred to as being “connected” or “coupled” to another feature, it can be directly connected or coupled to the other feature, or intervening features may be present. Furthermore, “connected” or “coupled” as used herein may include wirelessly connected or coupled. It will be understood that although the terms “first” and “second” are used herein to describe various features, these features should not be limited by these terms. These terms are used only to distinguish one feature from another feature. Thus, for example, a first user terminal could be termed a second user terminal, and similarly, a second user terminal may be termed a first user terminal without departing from the disclosed teachings. As used herein, the term “and/or” includes any and all combinations of one or more of the associated listed items. The symbol “/” is also used as a shorthand notation for “and/or”.

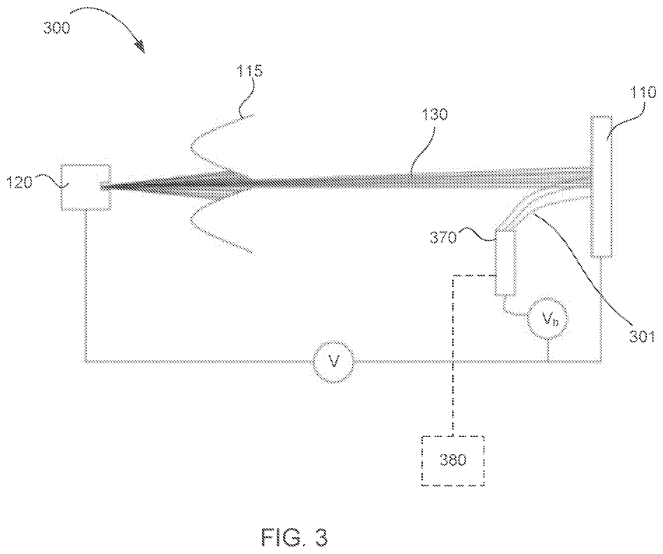

Referring to FIG. 3, in some embodiments, a beam target fusion system 300 includes an electron suppressor electrode 370 disposed at a distance from and asymmetrically with respect to the ion beam 130. The suppressor electrode 370 may be held at a bias voltage supplied by bias voltage source V_{b} with respect to the target 110. V_{b} may be a variable bias voltage source capable of biasing suppressor electrode 370 either positively or negatively with respect to target 110. Suppressor electrode 370 also may be coupled with diagnostic circuitry 380, as further described hereinbelow.

When negatively biased relative to the target, the electrode 370 repels backscattering electrons 301 and prevents them from returning to the ion source 120. When positively biased relative to the target (as shown in FIG. 3), the electrode 370 attracts the backscattering electrons 301, which has a similar effect of preventing the backscattering electrons 301 from returning to the ion source 120. Thus, the net current emitted from the ion source 120 is reduced, which, in turn, lowers the input power required to operate the system 300. In this way, the electron suppressor electrode 370 allows for the production of a given amount of fusion reaction byproducts using less input power, or alternatively, the production of a greater amount of fusion reaction byproducts using the same amount of input power. In sum, the use of the electron suppressor electrode 370 increases the efficiency of operation of the beam-target fusion assembly 300.

The optional diagnostic circuit 380 may play a particular role when the suppressor electrode 370 is positively biased relative to the target 110. In this configuration, rather than being repelled by the electrode 370 (as occurs when the electrode 370 is negatively biased with respect to target 110), electrons 301 emitted by the target 110 are attracted to the electrode 370 (as shown in FIG. 3). The current of electrons 301 can be measured by the diagnostic circuit 380, allowing for in-situ monitoring of the amount of back-streaming, and thus identifying certain important characteristics of the target.

Because the presently disclosed suppressor electrode operates well irrespective of whether it is aligned or symmetrically disposed with respect to the ion beam, there is no need for the ion beam to be aligned so as to travel through the suppressor electrode. As a result, an apparatus constructed in accordance with aspects of FIG. 3 can be made in configurations that are more compact and less expensive to produce than are those configured with a conventional suppressor electrode.

As discussed above, conventional electron suppressor electrodes typically are shaped as a ring surrounding the ion beam axis. The incoming ion beam passes through the ring electrode and strikes the target. By contrast, in embodiments of the present disclosure, an electron suppressor electrode is an elongated (“rod-like”) electrically conductive member. Such electron suppressor electrode may be placed in a variety of locations around and away from the axis of ion beam travel. This allows for apparatus designs that are more flexible and more compact, because the rod-shaped electrode can be smaller than ring-shaped electrodes and fit into smaller beam paths. Rod-shaped electrons are also less expensive to manufacture than ring-shaped electrodes.

Furthermore, conventional electron suppressor electrodes are negatively biased, and work to suppress the back-streaming electrons by repelling the electrons away from the electrode (and thus away from the ion source). Differently, electron suppressor electrodes according to embodiments herein can be operated with either negative or positive bias. When used with a positive bias, the suppressor electrode attracts (rather than repels) the back-streaming electrons. This also serves to prevent the back-streaming electrons from returning to the ion source, and produces the additional benefit of allowing the suppressor electrode to be attached to a diagnostic circuit that allows the back-streaming electron current to be measured and monitored.

Although the present embodiments have been described in detail, those skilled in the art will understand that various changes, substitutions, variations, enhancements, nuances, gradations, lesser forms, alterations, revisions, improvements and knock-offs of the embodiments disclosed herein may be made without departing from the spirit and scope of the embodiments in their broadest form.

What is claimed is:

1. A system, comprising:
a target;
an ion beam source configured to create a plasma from which an ion beam is emitted along an axis toward the target; and
an electron suppressor electrode disposed asymmetrically with respect to the ion beam, and configured to suppress back-streaming of electrons toward the ion beam source.

2. The system of claim 1, wherein the electron suppressor electrode comprises an elongated electrically conductive member disposed at a radial distance away from the axis.

3. The system of claim 1, further comprising a bias voltage source coupled to the electron suppressor electrode, whereby the electron suppressor electrode is held at a bias voltage with respect to the target.

4. The system of claim 3, wherein the bias voltage is negative.

5. The system of claim 3, wherein the bias voltage is positive.

6. The system of claim 5, further comprising a diagnostic circuit coupled to the electron suppressor electrode and configured to monitor electrons emitted by the target and impinging on the electron suppressor electrode.

7. The system of claim 3, wherein the bias voltage source is variable.

8. The system of claim 1, further comprising an extraction electrode positioned between the ion beam source and the target, and configured to extract ions from the plasma for creation of the ion beam.

9. A method of suppressing back-streaming of electrons toward an ion beam source configured to create a plasma from which an ion beam is emitted along an axis toward a target, the method comprising:
disposing an electron suppressor electrode asymmetrically with respect to the ion beam; and
biasing a voltage of the electron suppressor electrode relative to a voltage of the target to prevent back-streaming of electrons to the ion source.

10. The method of claim 9, wherein the electron suppressor electrode is positively biased with respect to the target, whereby back-streamed electrons from the target are attracted to the electron suppressor electrode.

11. The method of claim 9, wherein the electron suppressor electrode is negatively biased with respect to the target, whereby back-streamed electrons from the target are repelled by the electron suppressor electrode from returning toward the ion source.
